(19) United States
(12) Patent Application Publication
(10) Pub. No.: US 2018/0178730 A1
(43) Pub. Date: Jun. 28, 2018

(54) STOWABLE STEP FOR VEHICLE ACCESS

(71) Applicant: Ancra International LLC, Azusa, CA (US)

(72) Inventor: Howard T. Knox, Independence, KY (US)

(73) Assignee: Ancra International LLC, Azusa, CA (US)

(21) Appl. No.: 15/616,079

(22) Filed: Jun. 7, 2017

Related U.S. Application Data
(60) Provisional application No. 62/438,234, filed on Dec. 22, 2016.

(51) Int. Cl. B60R 3/02

(52) U.S. Cl. CPC B60R 3/02; E06C 5/04

(57) ABSTRACT

A stowable step for accessing a vehicle is provided. The stowable step includes a frame assembly and a step assembly carried by the frame assembly and movable between a fully extended position and a stowed position. The frame assembly defines a path of travel with a substantially “S” shape. This redesigned path of travel allows the step assembly to clear other structures (e.g., light tube structure) when moving between the fully extended position and stowed position.

### CROSS-REFERENCE TO RELATED APPLICATIONS

This application claims priority from U.S. Provisional Application No. 62/438,234, filed Dec. 22, 2016, the entirety of which is hereby fully incorporated by reference herein.

### TECHNICAL FIELD

The subject specification relates to a step used to access the inside or trunk of a vehicle, especially the trailer of a freight truck.

### BACKGROUND

Retractable staircases have been in use for decades. One widely used type of conventional retractable staircases is shown in FIGS. 1-2. As illustrated, this conventional retractable staircase has a pair of longitudinally aligned slots 92 for guiding the movement of the staircase 90 between an extended position and a retracted position. These substantially horizontal and rearwardly extending slots 92 terminate in a downwardly and rearwardly extending portion 98. Although this design often accommodates certain structures (e.g., bumper 96), it fails to contemplate the potential interference (shown in FIG. 1) between the staircase 90 and other structures (e.g., light tube structure 94) that are commonly employed below the frame of a vehicle. To remedy this problem, previous solutions included either inserting spacers (not shown) to mount the staircase lower or mounting the staircase further forward to allow the staircase to clear the light tube when moving between the extended and retracted position.

### BRIEF SUMMARY

A first representative embodiment of the disclosure is provided. The embodiment includes a stowable step for accessing a vehicle with a redesigned path of travel to accommodate other structures employed under the frame of a vehicle. The stowable step includes a frame assembly comprising a pair of mounting brackets aligned longitudinally, each mounting bracket extending between a forward end and a rearward end, when installed upon a vehicle the rearward end disposed proximate to an end (e.g., rear end, side end, etc.) of the vehicle and the forward end disposed inboard of that end of the vehicle, a bearing bar extending transversely and connecting the mounting brackets proximate the rearward ends of the mounting brackets, wherein the mounting brackets each define a guide slot aligned longitudinally, wherein the guide slots extending from the rearward ends to the forward ends of the mounting brackets, wherein each of the guide slots comprising a rearward portion, a middle portion, and a forward portion, the rearward portion extends downwardly as the rearward portion approaches the middle portion, the middle portion extends upwardly as the middle portion approaches the forward portion, and the forward portion extends horizontally, wherein the middle portion of the guide slots extend at a obtuse angle with respect to a surface upon which the vehicle rests. The stowable step further includes a step assembly carried by the frame assembly and movable between a fully extended position and a stowed position, the step assembly comprising a pair of side plates aligned longitudinally that extend between a rearward end and a forward end, a step plate positioned between the pair of side plates, a guide rod extending transversely through the pair of side plates proximate the forward ends of the side plates, the guide rod slidably engaging the guide slots for moving the step assembly between the fully extended position and the stowed position.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 (Prior Art) is a side view of a conventional type retractable staircase movable between an extended position and a retracted position.

FIG. 2 (Prior Art) is a perspective view of the conventional type retractable staircase in FIG. 1 deployed in the retracted position.

FIG. 3a is a perspective view of a stowable step for accessing vehicle with a redesigned path of travel deployed in a fully extended position.

FIG. 3b is a side view of the stowable step in FIG. 3a deployed in the fully extended position under a vehicle.

FIG. 4a is a side view of the mounting brackets of the stowable step in FIGS. 3a and 3b with a redesigned path of travel of a second shape.

FIG. 4b is a side view of the mounting brackets of the stowable step in FIGS. 3a and 3b with a redesigned path of travel of a third shape.

FIG. 4c is a side view of the mounting brackets of the stowable step in FIGS. 3a and 3b with a redesigned path of travel of a fourth shape.

FIG. 5 is a side view of the stowable step in FIGS. 3a and 3b about to move from the fully extended position to the stowed position.

FIG. 6 a side view of the stowable step in FIGS. 3a and 3b in the process of moving from the fully extended position to the stowed position.

FIG. 7a is a side view of the stowable step of FIGS. 3a and 3b deployed in a stowed position under the vehicle.

FIG. 7b is a perspective view of the stowable step of FIG. 7a deployed in the stowed position.

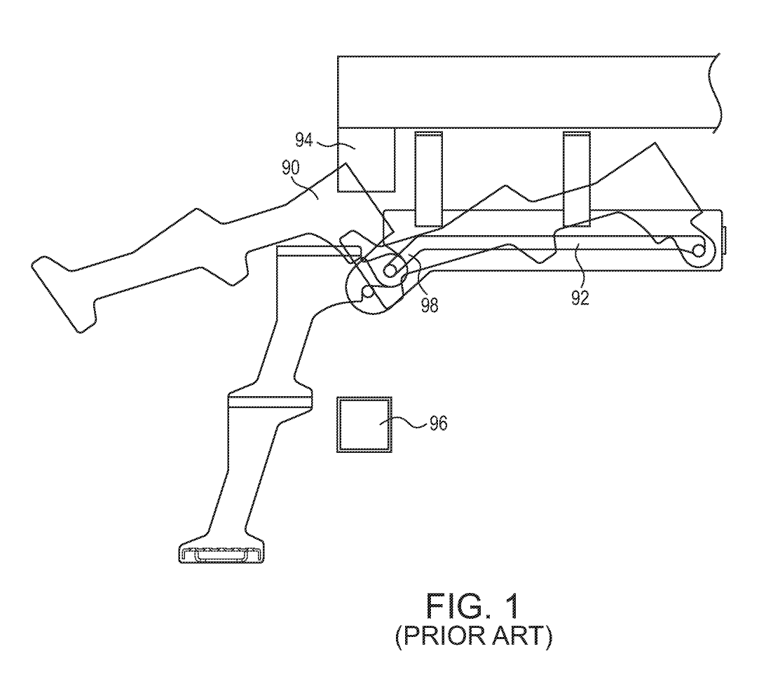

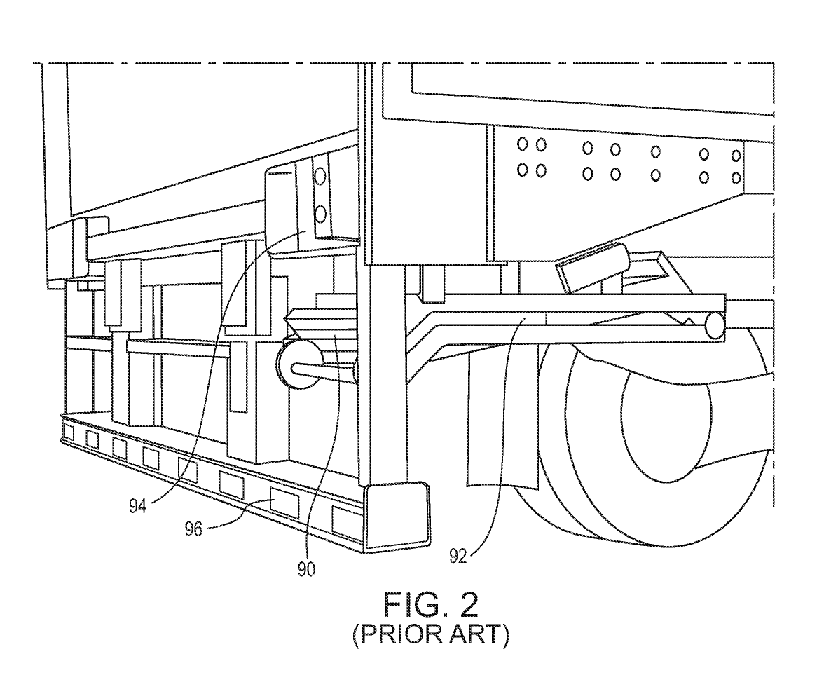

### DETAILED DESCRIPTION OF THE DRAWINGS AND THE PRESENTLY PREFERRED EMBODIMENTS

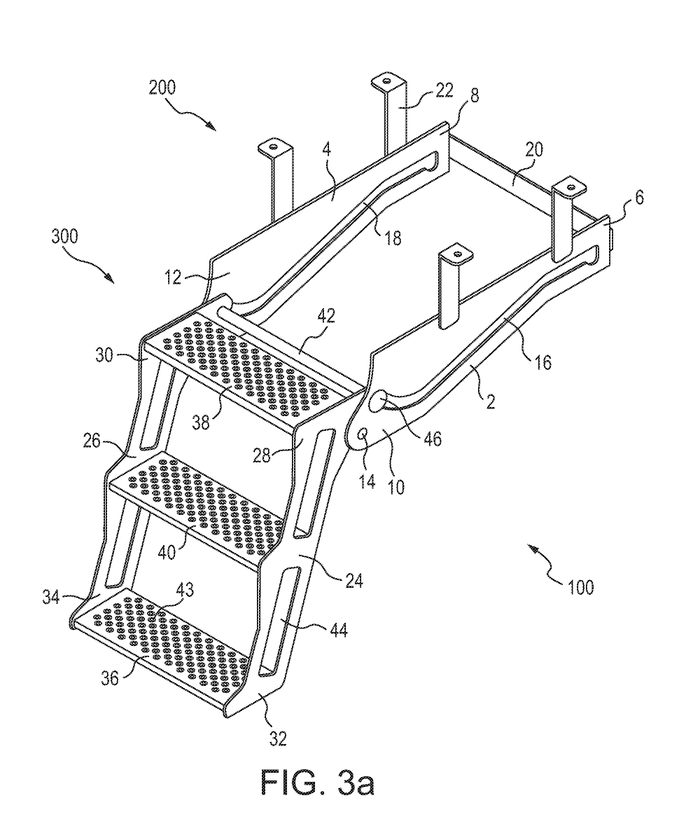

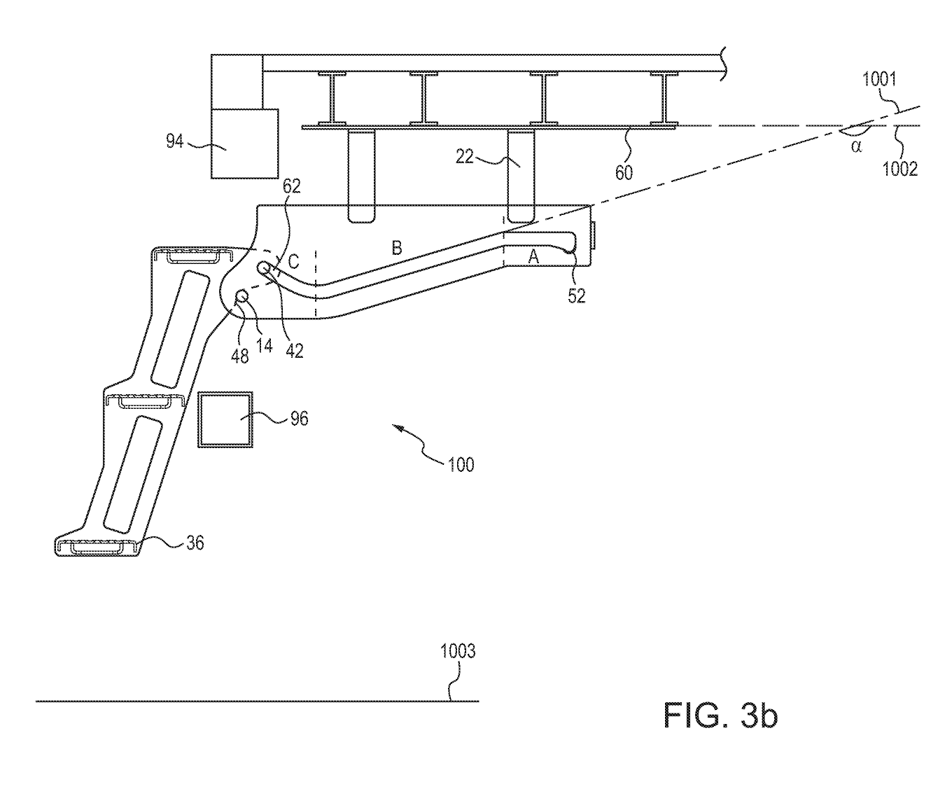

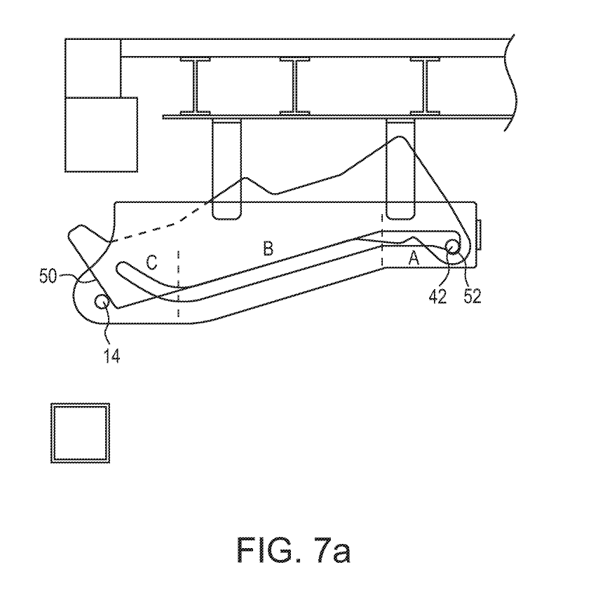

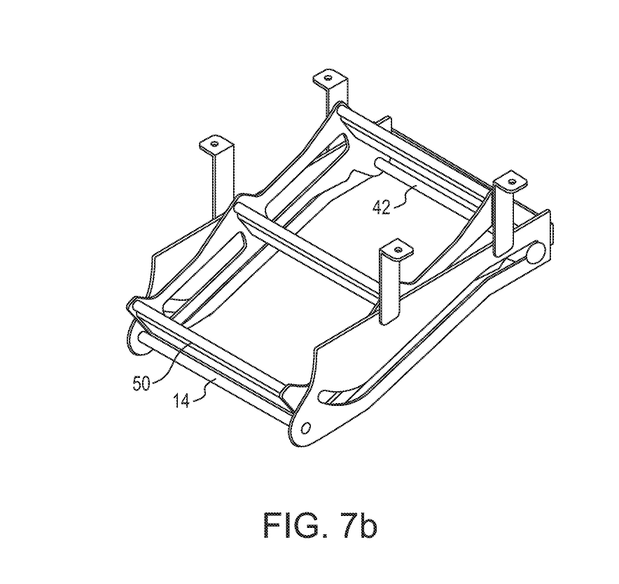

Turning now to FIGS. 3a-7b, a stowable step 100 is provided. The stowable step 100 is adapted for use by a person, such as a driver or a dock worker, for allowing the person to access the inside, trunk, or trailer of a vehicle. As discussed further below, the stowable step 100 may be removably connected to a vehicle or a trailer (FIG. 3b). The stowable step 100 includes a frame assembly 200 and a step assembly 300. The step assembly 300 is carried by the frame assembly 200 and movable between a fully extended position (FIGS. 3a & 3b) and a stowed position (FIGS. 7a & 7b).

Referring to FIGS. 3a and 3b, in some embodiments, the frame assembly 200 includes a pair of mounting brackets 2, 4 aligned longitudinally, each mounting bracket extending between a forward end 6, 8 and a rearward end 10, 12. A plurality of attaching members 22 are fixed to the mounting brackets 2, 4, the attachment members 22 are configured to structurally attach to the underframe 60 of a vehicle. When the frame assembly 200 is installed upon a vehicle via the attachment member 22, the rearward ends 10, 12 of the mounting brackets are disposed proximate to an end (e.g., rear end, side end, etc.) of the vehicle and the forward ends 6, 8 are disposed inboard of that end of the vehicle. A linking member 20 extends transversely and connects the mounting brackets 2, 4 proximate the forward ends 6, 8 of the mounting brackets. A bearing bar 14 extending transversely and connects the mounting brackets 2, 4 proximate the rearward ends 10, 12 of the mounting brackets. The mounting brackets 2, 4 each defines a guide slot 16, 18 aligned longitudinally. The guide slots 16, 18 have a substantially “S” shape extending from the rearward ends 10, 12 toward the forward ends 6, 8 of the mounting brackets. The guide slots 16, 18 are provided with a rearward portion C proximate the rearward ends 10, 12 of the mounting brackets, a forward portion A proximate the forward ends 6, 8 of the mounting brackets, and a middle portion B disposed between the rearward portion C and the forward portion A. The dotted line 1001 represents the general direction of the middle portion B of the guide slots 16, 18. The dotted line 1002 represents a plane defined by the underframe 60 of the vehicle, which is parallel to a surface 1003 upon which the vehicle rests upon. The middle portion B of the guide slots 16, 18 extend at an obtuse angle a with respect to the plane 1002 and thus the surface 1003. In some embodiments, the angle a may be about 160 degrees, while in other embodiments the angle a may be within the range of about 140 degrees to about 170 degrees, inclusive of all angles within this range, and specifically including 140, 145, 150, 155, 160, 165, and 170 degrees. The term “about” is defined herein to include the exact angle referenced as well as well as all angles within 5 degrees plus or minus the referenced range.

In some embodiments, the middle portion B of the guide slots 16, 18 is straight along its length.

In some embodiments, the middle portion B of the guide slots 16, 18 includes a changing angle for at least a portion of the length of the middle portion. In some embodiments, this changing angle is a continuously changing angle.

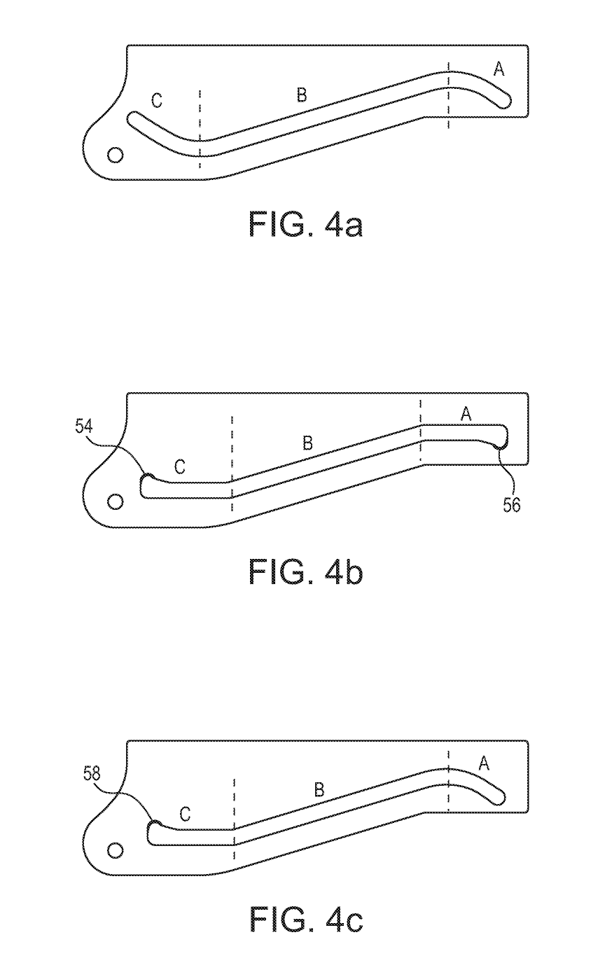

Referring to FIGS. 3b-4c, the substantially “S” shape guide slots may have multiple variations. As described below, in some embodiments, the guide slots 16, 18 include a recess on at least one end thereof for securely holding a guide rod 42 on the end.

In some embodiments (FIG. 3b), from the perspective of traveling from the rearward end to the forward end, the rearward portion C of the guide slots 16, 18 extends downwardly as the rearward portion C approaches the middle portion B, the middle portion B extends upwardly as the middle portion B approaches the forward portion A, and the forward portion A extends horizontally. In some embodiments, the forward portion A includes a recess 52 for securely holding a guide rod 42 on the end.

In some embodiments (FIG. 4a), from the perspective of traveling from the rearward end to the forward end, the rearward portion C of the guide slots 16, 18 extends downwardly as the rearward portion C approaches the middle portion B, the middle portion B extends upwardly as the middle portion B approaches the forward portion A, and the forward portion A extends downwardly.

In some embodiments (FIG. 4b), from the perspective of traveling from the rearward end to the forward end, the rearward portion C of the guide slots 16, 18 extends horizontally as the rearward portion C approaches the middle portion B, the middle portion B extends upwardly as the middle portion B approaches the forward portion A, and the forward portion A extends horizontally. In some embodiments, the rearward portion C includes a recess 54 for securely holding a guide rod 42 on the end. In some embodiments, the forward portion A includes a recess 56 for securely holding a guide rod 42 on the end.

In some embodiments (FIG. 4c), from the perspective of traveling from the rearward end to the forward end, the rearward portion C of the guide slots 16, 18 extends horizontally as the rearward portion C approaches the middle portion B, the middle portion B extends upwardly as the middle portion B approaches the forward portion A, and the forward portion A extends downwardly. In some embodiments, the rearward portion C includes a recess 58 for securely holding a guide rod 42 on the end.

Referring to FIGS. 3a and 3b, in some embodiments, the step assembly 300 includes a pair of side plates 24, 26 aligned longitudinally that extend between a rearward end 32, 34 and a forward end 28, 30. A first step plate 36 is positioned between the pair of side plates 24, 26. A guide rod 42 extends transversely through the pair of side plates 24, 26 proximate the forward ends 28, 30 of the side plates. The guide rod 42 slidably engages the guide slots 16, 18 for moving the step assembly 300 between a fully extended position (FIGS. 3a & 3b) and a stowed position (FIGS. 7a & 7b).

In some embodiments, fastening means 46, such as a cotter pin, are provided on each end of the guide rod 42 to prevent outward axial movement of the guide rod 42 relative to the guide slots 16, 18.

In some embodiments, each of the side plates 24, 26 further includes a notch 48 proximate the forward ends 28, 30 of the side plates. The notches are adapted for receiving the bearing bar 14 when the steps assembly 100 is disposed in the fully extended position.

In some embodiments, the side plates 24, 26 are slotted to reduce weight.

In some embodiments, the first step plate 36 is positioned proximate the rearward ends 32, 34 of the side plates 24, 26. In some embodiments, the step assembly 300 further includes a second step plate 38 positioned between the side plates 24, 26 and proximate the forward ends 28, 30 of the side plates. In some embodiments, the step assembly 300 further includes a third step plate 40 positioned between the side plates 24, 26 and between the first and second step plates 36, 38.

In some embodiments, slots or holes 43 are provided on at least one of the step plates to increase traction and/or to promote drainage or for other purposes.

As can be understood with reference to FIGS. 3a-7b, a user may move the stowable step between a fully extended position and a stowed position by pushing and pulling the step assembly 100 such that the guide rod 42 slides along the substantially “S” shape path of travel defined by the guide slots 16, 18. This redesigned path of travel allows the step assembly 300 to clear other structures (e.g., light tube structure 94) during its movement. The current design provides several benefits. For example, spacers are no longer needed for installing the stowable step thus avoiding unnecessary difficulty of installation. The elimination of spacers also increases user safety because spacers put the top step a several inches lower than it was designed to be making the first step out of the vehicle more difficult. User safety is also improved because there is no longer any need to install the stowable step further forward to accommodate other structures, which results in better exposure of the step plates for footing.

Referring to FIG. 3b, when the stowable step 100 is deployed in the fully extended position, the step plate 36 is positioned above the surface 1003 upon which the vehicle rests. The guide rod 42 is received in the rear end 62 of the rearward portion C of the guide slots 16, 18. The bearing bar 14 supports the step assembly 100 and is received in the notch 48 on the side plates 24, 26. In some embodiments, the stowable step 100 is of such dimension that the step assembly 300 does not interfere with the bumper 96 when the stowable step is deployed in the fully extended position.

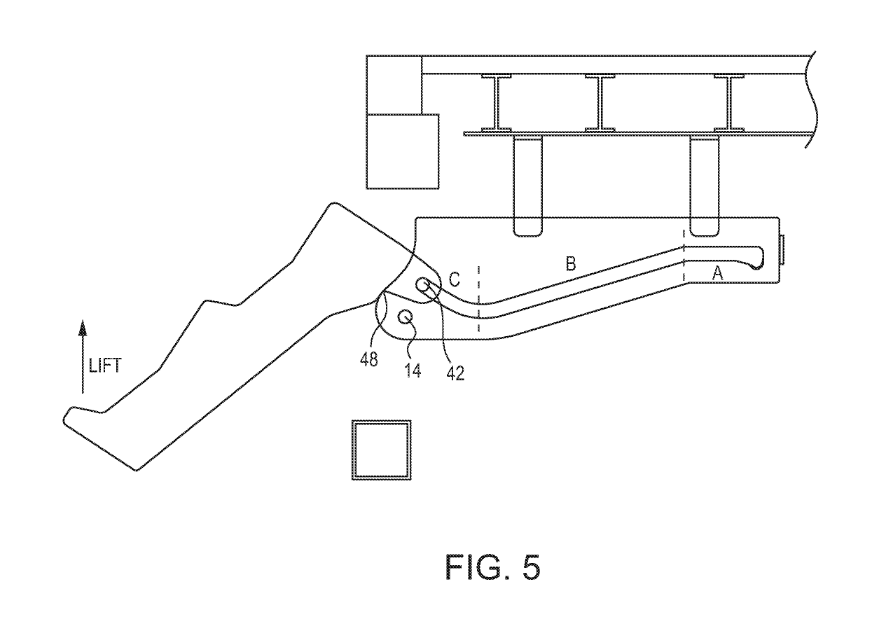

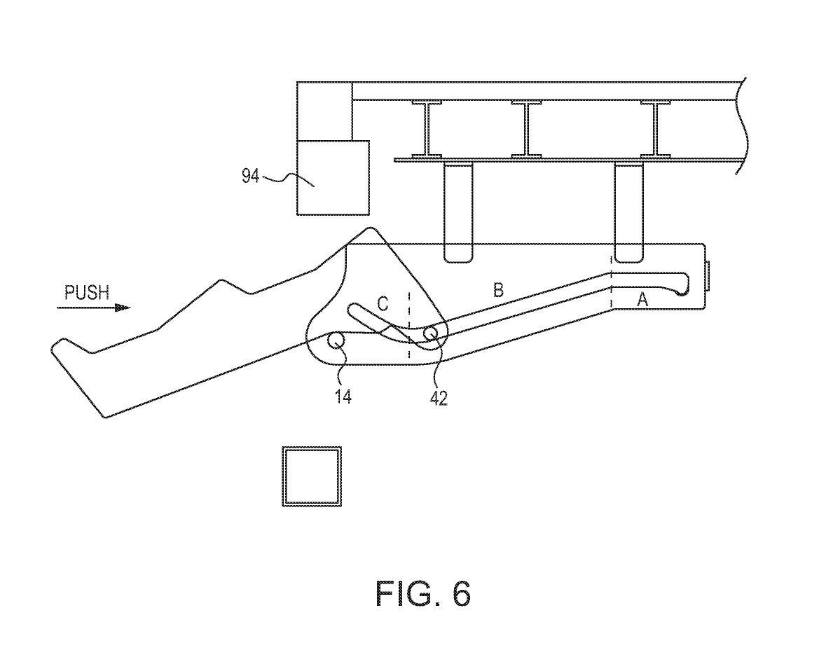

Referring to FIGS. 5-7b, to move the stowable step to the stowed position, the user only needs to first lift (FIG. 5) the step assembly 300 to remove the bearing bar 14 from the notch 48, then push (FIG. 6) the step assembly 300 forwardly such that the guide rod 42 travels along the substantially “S” shape guide slots 16, 18 until the guide rod 42 is received in the recess 52 provided on the forward portion A. In some embodiments, a bottom surface 50 of the step plate 36 rests upon the bearing bar 14 when the stowable step is disposed in the stowed position.

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

1. A stowable step for accessing a vehicle, comprising:
a frame assembly comprising a pair of mounting brackets aligned longitudinally, each mounting bracket extending between a forward end and a rearward end, when installed upon a vehicle the rearward end disposed proximate to an end of the vehicle and the forward end disposed inboard of that end of the vehicle, a bearing bar extending transversely and connecting the mounting brackets proximate the rearward ends of the mounting brackets, wherein the mounting brackets each defines a guide slot aligned longitudinally, the guide slots having a substantially “S” shape extending from the rearward ends to the forward ends of the mounting brackets, wherein a middle portion of the guide slots extending at a obtuse angle with respect to a surface upon which the vehicle rests; and
a step assembly carried by the frame assembly and movable between a fully extended position and a stowed position, the step assembly comprising a pair of side plates aligned longitudinally that extend between a rearward end and a forward end, a step plate positioned between the pair of side plates, a guide rod extending transversely through the pair of side plates proximate the forward ends of the side plates, the guide rod slidably engaging the guide slots for moving the step assembly between the fully extended position and the stowed position.

2. A stowable step for accessing a vehicle of claim 1, further comprising a linking member extending transversely and connecting the mounting brackets proximate the forward ends of the pair of mounting brackets.

3. A stowable step for accessing a vehicle of claim 1, further comprising an attachment member fixed to the mounting bracket, the attachment member configured to structurally attach to a vehicle.

4. A stowable step for accessing a vehicle of claim 1, wherein each of the pair of side plates comprises a notch proximate the forward end, the notch adapted for receiving the bearing bar when the steps assembly is disposed in the fully extended position.

5. A stowable step for accessing a vehicle of claim 1, wherein in the stowed position a bottom surface of the step plate rests upon the bearing bar.

6. A stowable step for accessing a vehicle of claim 1, wherein the side plates of the steps assembly are slotted.

7. A stowable step for accessing a vehicle of claim 1, wherein the step plate is a first step plate positioned proximate the rearward ends of the side plates.

8. A stowable step for accessing a vehicle of claim 7, wherein the step assembly further comprises a second step plate positioned between the side plates and proximate the forward ends of the side plates.

9. A stowable step for accessing a vehicle of claim 8, wherein the step assembly further comprises a third step plate positioned between the side plates and between the first and second step plates.

10. A stowable step for accessing a vehicle of claim 7, wherein slots or holes are provided on the first step plate.

11. A stowable step for accessing a vehicle of claim 1, wherein the guide slots further comprises a recess on at least one end thereof for securely holding the guide rod on the end.

12. A stowable step for accessing a vehicle of claim 1, further comprising a fastening means on each end of the guide rod to prevent outward axial movement of the guide rod relative to the guide slots.

13. A stowable step for accessing a vehicle of claim 12, wherein the fastening means is a cotter pin.

14. A stowable step for accessing a vehicle of claim 1, wherein the substantially “S” shape guide slots each comprise a rearward portion, a middle portion, and a forward portion, the rearward portion extends downwardly as the rearward portion approaches the middle portion, the middle portion extends upwardly as the middle portion approaches the forward portion, and the forward portion extends horizontally.

15. A stowable step for accessing a vehicle of claim 14, wherein the forward portion of the substantially “S” shape is recessed downward.

16. A stowable step for accessing a vehicle of claim 1, wherein the substantially “S” shape guide slots each comprise a rearward portion, a middle portion, and a forward portion, wherein the rearward portion extends downwardly as the rearward portion approaches the middle portion, the middle portion extends upwardly as the middle portion approaches the forward portion, and the forward portion extends downwardly.

17. A stowable step for accessing a vehicle of claim 1, wherein the substantially “S” shape guide slots each comprise a rearward portion, a middle portion, and a forward portion, wherein the rearward portion extends horizontally as the rearward portion approaches the middle portion, the middle portion extends upwardly as the middle portion approaches the forward portion, and the forward portion extends horizontally.

18. A stowable step for accessing a vehicle of claim 17, wherein the forward portion of the substantially “S” shape is recessed downward.

19. A stowable step for accessing a vehicle of claim 17, wherein the rearward portion of the substantially “S” shape is recessed upward.

20. A stowable step for accessing a vehicle of claim 1, wherein the substantially “S” shape guide slots each comprise a rearward portion, a middle portion, and a forward portion, the rearward portion extends horizontally as the rearward portion approaches the middle portion, the middle portion extends upwardly as the middle portion approaches the forward portion, and the forward portion extends downwardly.

21. A stowable step for accessing a vehicle of claim 20, wherein the rearward portion of the substantially “S” shape is recessed upward.

22. A stowable step for accessing a vehicle of claim 1, wherein the middle portion of the guide slots is straight along its length.

23. A stowable step for accessing a vehicle of claim 1, wherein the middle portion of the guide slots includes a changing angle for at least a portion of the length of the middle portion.

24. A stowable step for accessing a vehicle of claim 23, wherein the changing angle is a continuously changing angle.

25. A stowable step for accessing a vehicle, comprising:
a frame assembly comprising a pair of mounting brackets aligned longitudinally, each mounting bracket extending between a forward end and a rearward end, when installed upon a vehicle the rearward end disposed proximate to an end of the vehicle and the forward end disposed inboard of that end of the vehicle, a bearing bar extending transversely and connecting the mounting brackets proximate the rearward ends of the mounting brackets, wherein the mounting brackets each define a guide slot aligned longitudinally, wherein the guide slots extending from the rearward ends to the forward ends of the mounting brackets, wherein each of the guide slots comprising a rearward portion, a middle portion, and a forward portion, wherein the rearward portion extending downwardly as the rearward portion approaches the middle portion, the middle portion extending upwardly as the middle portion approaches the forward portion, and the forward portion extending horizontally, wherein the middle portion of the guide slots extending at a obtuse angle with respect to a surface upon which the vehicle rests; and
a step assembly carried by the frame assembly and movable between a fully extended position and a stowed position, the step assembly comprising a pair of side plates aligned longitudinally that extend between a rearward end and a forward end, a step plate positioned between the pair of side plates, a guide rod extending transversely through the pair of side plates proximate the forward ends of the side plates, the guide rod slidably engaging the guide slots for moving the step assembly between the fully extended position and the stowed position.
